(19) United States
(12) Patent Application Publication
(10) Pub. No.: US 2007/0095812 A1
(43) Pub. Date: May 3, 2007

(54) In-situ wafer parameter measurement method employing a hot susceptor as a reflected light source

(76) Inventor: Charles W. Schietinger, Milwaukie, OR (US)

Correspondence Address: STOEL RIVES LLP, 900 SW FIFTH AVENUE, SUITE 2600, PORTLAND, OR, 97204-1268, US

(21) Appl. No.: 11/044,842

(22) Filed: Jan. 26, 2005

Related U.S. Application Data
(63) Continuation of application No. 10/202,498, filed on Jul. 23, 2002, now abandoned.
(60) Provisional application No. 60/307,423, filed on Jul. 23, 2001.

(51) Int. Cl. F27B 5/14; F27D 11/00

(52) U.S. Cl. 219/390

(57) ABSTRACT

A semiconductor wafer temperature measurement method takes advantage of the tight control of the surface conditions and temperature of a hot susceptor, which tight control provides known and reproducible radiation emissions from the hot susceptor. The known amount of radiation emitted by the hot susceptor is employed as a stable radiation source for making precise reflectance and emission measurements of the semiconductor wafer.

### RELATED APPLICATIONS

This is a continuation of U.S. patent application Ser. No. 10/202,498, filed Jul. 23, 2002, which claims benefit of U.S. Provisional Patent application No. 60/307,423, filed Jul. 23, 2001.

### FEDERALLY SPONSORED RESEARCH OR DEVELOPMENT

Not applicable.

### TECHNICAL FIELD

This invention relates to radiometric temperature measurement systems (also known as “pyrometers”) and more particularly to a method employing measuring the change in hot susceptor radiation reflected by a target medium as it is moved into contact with the hot susceptor.

### BACKGROUND OF THE INVENTION

Pyrometer-based temperature measurement systems have a long development history. For example, even before 1930, U.S. Pat. Nos. 1,318,516; 1,475,365; and 1,639,534 all described early pyrometers. In 1933, U.S. Pat. No. 1,894,109 to Marcellus described a pyrometer employing an optical “lightpipe.” In 1955, U.S. Pat. No. 2,709,367 to Bohnet described a pyrometer in which sapphire and curved sapphire lightpipes are used in collection optics. In 1971, U.S. Pat. No. 3,626,758 to Stewart described using quartz and sapphire lightpipes with a blackbody sensor tip. Then in 1978, U.S. Pat. No. 4,075,493 to Wickersheim described a modem flexible fiber optic thermometer.

In the 1980s, U.S. Pat. No. 4,348,110 to Ito described electronic improvements to pyrometers, such as an integrating photo-detector output circuit. Then U.S. Pat. Nos. 4,576,486; 4,750,139; and 4,845,647, all to Dils, described further improvements to electronics, fiber-optics, sapphire rods, and blackbody emission temperature measurements.

In the 1990s, many patents issued that describe the use of pyrometers in semiconductor processing. For example, in 1990, U.S. Pat. No. 4,956,538 to Moslehi described using fiber optic lightpipes for wafer temperature measurements in rapid thermal processing (“RTP”) applications. In 1992, U.S. Pat. No. 5,154,512 to Schietinger described using a fiber optic thermometer with wavelength selective mirrors and modulated light to measure semiconductor wafer temperatures. In 1998, U.S. Pat. No. 5,717,608 to Jenson described using an integrating amplifier chip and fiber-optics to measure semiconductor wafer temperatures, and U.S. Pat. No. 5,815,410 to Heinke described an infrared (“IR”) sensing thermometer using an integrating amplifier. Then in 1999, U.S. Pat. No. 5,897,610 to Jensen described the benefits of cooling pyrometers, and U.S. Pat. No. 6,007,241 to Yam described yet another fiber optic pyrometer for measuring semiconductor wafer temperatures.

As one can see from these prior patents, pyrometer systems are commonly used for measuring the temperature of semiconductor silicon wafers housed within a process chamber while forming integrated circuits (“ICs”) on the wafer. Virtually every process step in silicon wafer fabrication depends on the measurement and control of wafer temperature. As wafer sizes increase and the critical dimension of very large scale ICs scales deeper into the sub-micron range, the requirements for wafer-to-wafer temperature repeatability during processing become ever more demanding.

Processes such as physical vapor deposition (“PVD”), high-density plasma chemical vapor deposition (“HDP-CVD”), epitaxy, and RTP can be improved if the wafer temperature is accurately measured and controlled during processing. In RTP there is a special importance to temperature monitoring because of the high temperatures and the importance of tightly controlling the thermal budget, as is also the case for Chemical Mechanical Polishing (“CMP”) and Etch processes.

As wafer sizes increase, the cost of each wafer increases geometrically, and the importance of high quality in-process temperature monitoring increases accordingly. Inadequate wafer temperature control during processing reduces fabrication yields and directly translates to lost revenues.

In addition to conventional pyrometry, the most common in-situ temperature sensing techniques employed by semiconductor processing wafer fabs and foundries also includes thermocouples and advanced pyrometry.

Thermocouples are easy to use, but their reliability and accuracy are sometimes questionable because of measurement delays. Thermocouples are only accurate when the wafer is in thermal equilibrium with its surroundings and the thermocouple is contacting or embedded in that environment. Otherwise, the thermocouple reading might be far from the correct wafer temperature. For example, in PVD applications, while the thermocouple embedded in the heated chuck (susceptor) provides a temperature measurement that resembles that of the wafer, there are large offsets between the wafer and the thermocouple. These offsets are a function of gas pressure and heat transfer. Despite delays, thermocouples often provide a good measurement of the hot susceptor temperature.

In conventional optical pyrometry, a pyrometer deduces the wafer temperature from the intensity of radiation emitted by the wafer. The pyrometer typically collects the radiation from the wafer through an interface employing a lens or a quartz or sapphire rod. Such interfaces have been used with PVD, HDP-CVD, RTP, and Etch. While conventional optical pyrometers are often superior to the use of thermocouples, there are measurement inaccuracy problems caused by background light, wafer transmission, emissivity, and signal-to-noise ratio.

Advanced pyrometry offers some satisfactory temperature monitoring solutions for semiconductor wafer production applications. “Optical Pyrometry Begins to Fulfill its Promise,” by Braun, Semiconductor International, March 1998, describes advanced pyrometry methods that overcome some limitations of conventional pyrometry. As such, optical pyrometers and fiber optic thermometers employing the Planck Equation are now commonly used for in-situ semiconductor wafer measurement. However, numerous problems and limitations are still encountered when measuring wafer temperature using “Planck” radiation (light) emitted by the wafer. There are numerous problems when measuring wafers at temperatures below about 400° C.: 1) minimal signal levels generated by the photo detector because the very small amount of radiation emitted by the wafer; 2) the wafer is semi-transparent at low temperatures and long wavelengths (greater then 900 nm); and 3) the background light is often larger than the emitted wafer signal and causes large errors when it enters the collection optics. Moreover, the often unknown emissivity of the object being measured increases the difficulty of achieving accurate temperature measurements.

What is still needed, therefore, is an advanced pyrometer system and measurement method that provides accurate and repeatable temperature measurements of an object, such as a semiconductor wafer, down below 400° C. and ideally to about room temperature without contacting the object being measured.

### SUMMARY OF THE INVENTION

An object of this invention is, therefore, to provide a method for performing non-contacting temperature measurements of target media, such as semiconductor wafers.

The measurement method of this invention takes advantage of the fact that the susceptor (wafer chuck or wafer holder) is at a known temperature and, therefore, emits a known amount of light (radiation). The hot susceptor emission is well-known because of the known temperature of the susceptor and the Planck equation. The known amount of light is used to determine the wafer reflectivity by measuring how much of the light reflects off the wafer. Wafer emissivity is then calculated by applying Kirchoff's law (1 minus reflectivity equals emissivity), which is valid because of the wide field-of-view of the radiometric system lightpipe employed and the near hemispherical emission pattern from the hot susceptor.

Because of the well controlled geometry and known optical conditions, the wafer surface roughness can also be calculated from the change in reflected intensity. The amount of reflected light changes as a function of wafer roughness and illumination angle. The illumination angles change because the geometry changes as the wafer is lowered toward the hot susceptor. Wafer roughness is determined by running a set of test wafers each having a different roughness and plotting the light levels as a function of distance and roughness. After the test wafers have been run, the in-situ wafer roughness can be determined in real time.

An advanced pyrometer system suitable for use with this invention has reduced optical losses, better background radiation blocking, improved signal-to-noise ratio, and improved signal processing to achieve improved accuracy and temperature measurement capabilities ranging from about 10° C. to about 4,000° C.

The pyrometer system includes collection optics that acquire radiation and directly couples it to an optional filter and/or a photo detector. The collection optics may include lens systems, optic lightpipes, and flexible fiber optics. The preferred collection optic is a yttrium-aluminum-garnet (“YAG”) light guide rod. The photo detectors are formed from silicon, InGaAs or, preferably, doped AlGaAs having narrow bandpass detection characteristics centered near 900 nm.

The system further includes an amplifier that acquires and conditions signals as small as 10⁻¹⁶ amperes for detection and measurement. A signal processor converts the amplified signal into a temperature reading. This processing is a combination of electrical signal conditioning, analog-to-digital conversion, correction factors, and software algorithms, including the Planck equation.

In a preferred measurement method, a cool semiconductor wafer is moved into position a distance spaced apart from a heated susceptor. As it is moved into position, the cool semiconductor wafer emits a relatively small amount of emitted radiation, which is preferably, but not necessarily sensed by a radiometric system of this invention. The emitted radiation increases when the semiconductor wafer is heated during subsequent lowering toward the hot susceptor. Before lowering the semiconductor wafer, the emitted radiation from the hot susceptor that is reflected by the semiconductor wafer as reflected radiation provides a baseline radiation measurement for comparing with measurements taken during the subsequent downward motion of the semiconductor wafer.

When the semiconductor wafer is moved into the process chamber and above the hot susceptor, the emission (light) from the susceptor is reflected off the wafer and into the radiometric system. The amount of susceptor emission is known from its temperature and the Planck equation. The amount of reflected light is measured by the radiometric system in real time as the distance between the susceptor and the wafer diminishes, that is, as the wafer and/or the hot susceptor are moved toward one another and eventually into contact. The change in reflected light level under the well known and controlled geometric conditions, provides the necessary parameters for determining wafer reflectivity, emissivity, and roughness.

Additional objects and advantages of this invention will be apparent from the following detailed description of preferred embodiments thereof that proceed with reference to the accompanying drawings.

### BRIEF DESCRIPTION OF THE DRAWINGS

FIG. 1 is a combined pictorial and corresponding schematic block diagram of a pyrometer system suitable for use with this invention.

FIG. 2 is a simplified electrical block diagram of the electronic circuitry portion of the pyrometer system of FIG. 1.

FIG. 3 is a simplified pictorial view of a prior art optical pyrometer employing a first lens for collimating radiation through a filter and a second lens for focusing the filtered radiation on a silicon detector.

FIG. 4 is a simplified pictorial view of an optical pyrometer suitable for use with this invention employing a single lens for focusing radiation on a wavelength selective AlGaAs detector.

FIG. 5 is a simplified pictorial view of a prior art pyrometer system employing optical fiber cables to couple emitted radiation to detectors.

FIG. 6 is a simplified pictorial view of a pyrometer system suitable for use with this invention employing direct coupling of emitted radiation to detectors.

FIG. 7 is a sectional side view of a prior art light guide rod and detector mounting system in which the optical faces of the light guide rod and detector are recessed within threaded housings making cleaning difficult.

FIG. 8 is a sectional side view of a light guide rod and detector mounting system suitable for use with this invention in which the optical faces of the light guide rod and detector are flush to the edges of their respective housings and, therefore, easy to clean.

FIG. 9 is a graphical representation of a radiation transmission response as a function of wavelength for a reflective filter suitable for use with this invention.

FIG. 10 is a simplified schematic pictorial view of a pyrometer system suitable for use with this invention employed in a typical semiconductor process temperature measurement application.

FIG. 11 are graphs representing the transmission of radiation through a silicon wafer as a function of wavelength and temperature.

FIGS. 12A and 12B is graphs representing respectively the optical density and transmittance as a function of wavelength and radiation incidence angles of a short wavelength pass filter suitable for use with this invention.

FIG. 13 is a graph representing the absorption coefficient of various detector materials as a function of wavelength.

FIG. 14 is a graph representing the photo sensitivity of various detector materials as a function of wavelength.

FIG. 15 is a graph representing photo sensitivity versus wavelength as a function of photo detector temperature.

FIG. 16 is a set of graphs representing wavelength shift as a function of temperature for typical infrared interference filters.

FIG. 17 is a simplified pictorial schematic diagram representing a semiconductor wafer temperature measurement method of this invention employing radiation emitted by a hot susceptor and reflected by the semiconductor wafer.

FIG. 18 is a simplified pictorial elevation view of an exemplary semiconductor wafer processing apparatus suitable for carrying out the temperature measurement method of this invention.

### DETAILED DESCRIPTION OF PREFERRED EMBODIMENTS

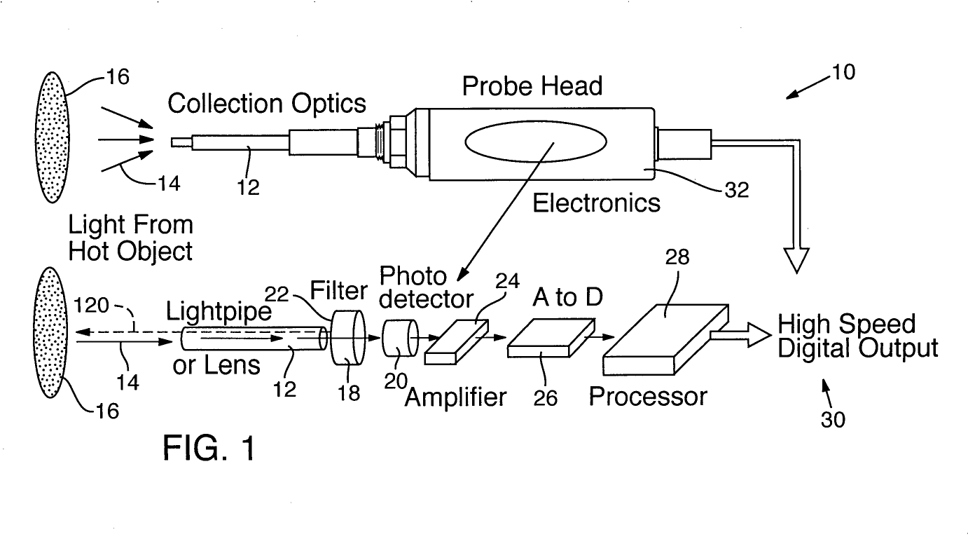

FIG. 1 shows a radiometric system 10 that is suitable for use with the measurement methods of this invention and includes collection optics 12 for acquiring emitted radiation 14 from a target medium, such as an object 16, which is preferably a semiconductor wafer. Collection optics 12 direct radiation 14 to a wavelength selective filter 18 and a photo detector 20. Collection optics 12 may alternatively include rigid or flexible fiber optic light pipes and/or a lens system for measuring the temperature of predetermined areas on object 16. The target medium may include gases, plasmas, heat sources, and other non-solid target media. While radiometric system 10 is preferred, virtually any pyrometer may be employed with the measurement methods of this invention.

Wavelength selective filter 18 selects which wavelengths of radiation 14 are measured. A preferred embodiment of filter 18 includes a hot/cold mirror surface 22 for reflecting unneeded wavelengths of radiation 14 back toward object 16. Skilled workers will recognize that filter 18 and hot/cold mirror surface 22 should be housed to maintain them in a clean and dry condition.

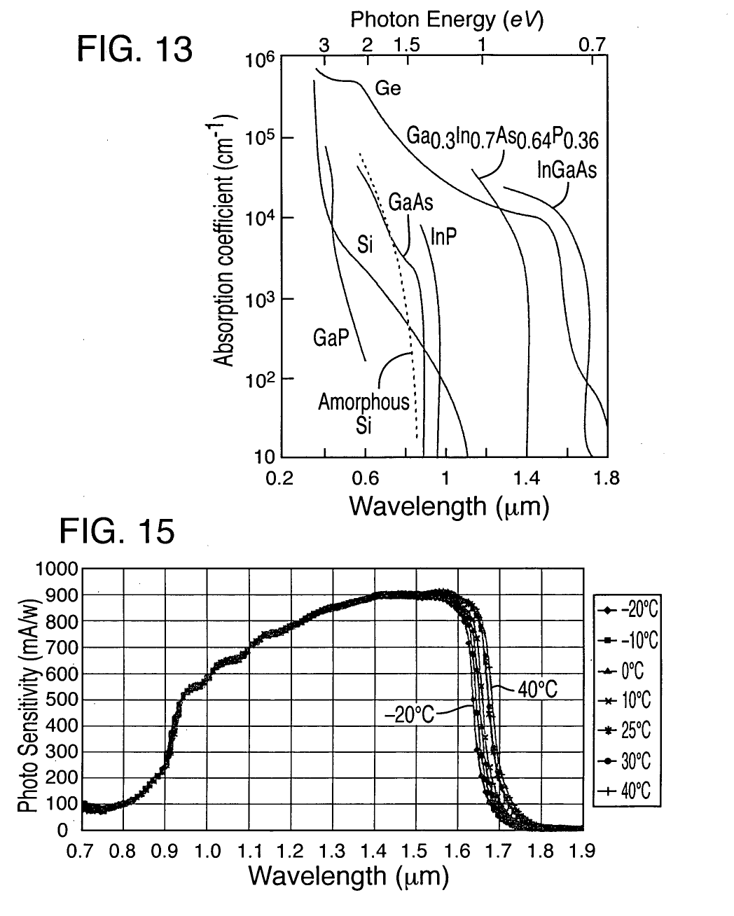

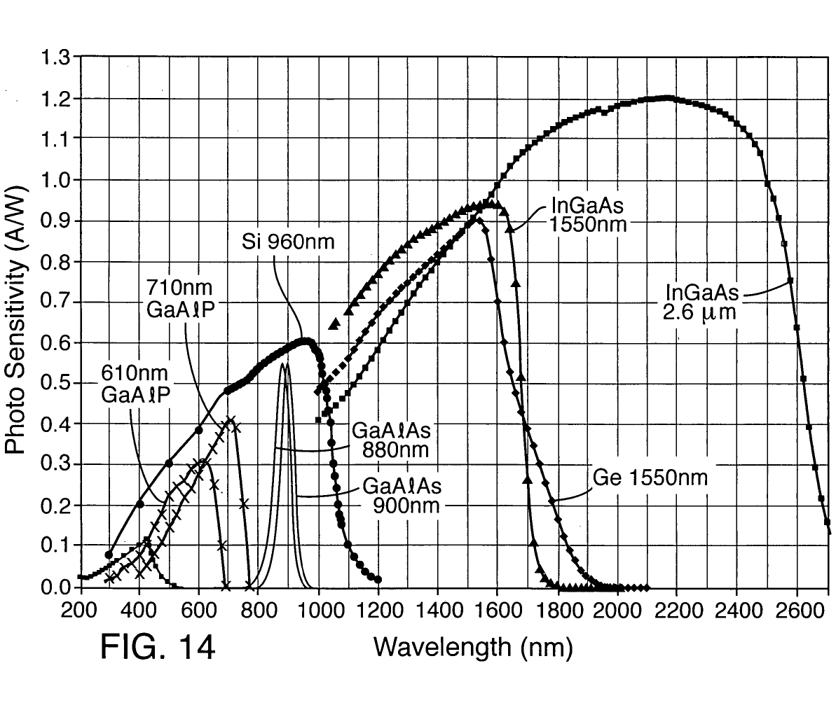

Photo detector 20 converts radiation 14 into an electrical signal. Photo detector 20 can be a high efficiency solid-state detector device formed from silicon, InGaAs or a specially doped AlGaAs material having a narrow bandpass detection characteristic centered near or around 900 nm. Detector 20 is described in more detail with reference to FIGS. 13 and 14.

Radiometric system 10 further includes an amplifier 24 that receives the small electrical signal from photo detector 20 and amplifies the signal to a level suitable for further processing. Amplifier 24 allows measuring electrical signals as small as 10⁻¹⁶ amps.

Radiometric system 10 further includes an analog-to-digital converter (“ADC”) 26 for converting the amplified electrical signal into a digital signal and a signal processor 28 for processing the digital signal into a temperature reading. The processing includes software algorithms employing the Planck equation.

Radiometric system 10 generates a high-speed digital output signal 30, which can be viewed as temperature measurements on a personal or host computer running conventional user software or, preferably, a Windows®-based user software product named TemperaSure™, which is available from Engelhard Corporation, located in Fremont, Calif.

Radiometric system 10 further includes a generally tubular housing 32 that encloses at least photo detector 20, amplifier 24, ADC 26, and signal processor 28. Housing 32 is preferably at least about 2.54 cm (1 inch) in diameter and at least about 10.16 cm (4 inches) long. Of course, the shape and dimensions of housing 32 may vary to suit different applications.

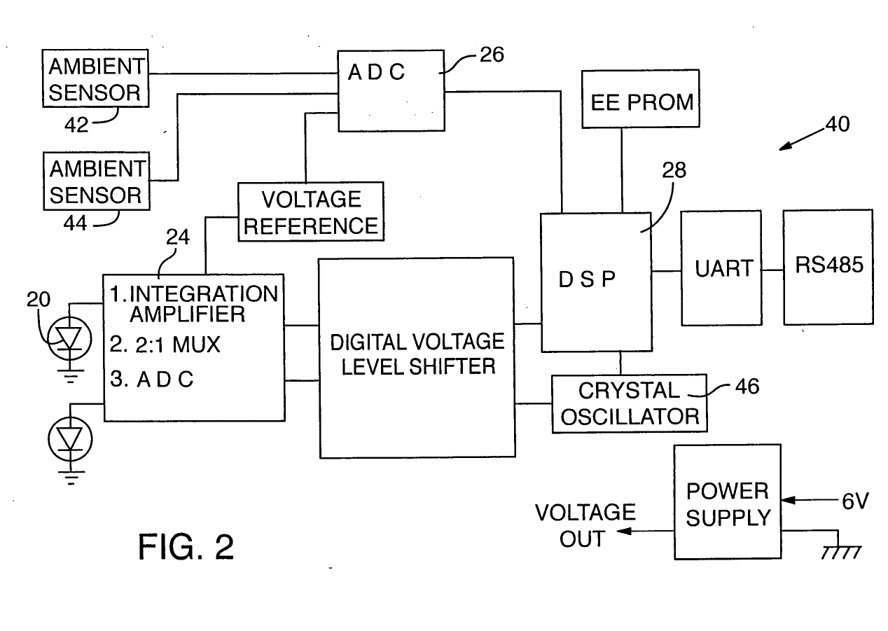

FIG. 2 shows a block diagram of electronic circuitry 40 portions of radiometric system 10, which circuitry is preferably included on a printed circuit board (not shown) that fits within housing 32. Electronic circuitry 40 utilizes significantly smaller components and arrays them in a highly compact format such that the overall instrument size is reduced dramatically from prior pyrometers. This form factor enables direct coupling of photo detector 20 and electronic circuitry 40 to collection optics 12 and, therefore, eliminates the undesirable fiber cable often found in prior optical thermometers. Eliminating the fiber cable in semiconductor temperature measurement applications reduces optical losses and signal variations.

Electronic circuitry 40 preferably includes photo detector 20 and an array of IC chips for amplifying and integrating (or averaging) the electrical signal generated by photo detector 20. Electronic circuitry further includes two or more temperature sensors 42 and 44 to monitor ambient temperatures of components, such as photo detector 20, amplifier 24, wavelength selective filter 18, and a timing circuit 46.

Compensating target temperatures based on information gained from sensors 42 and 44 accounts for deviations in component performance having differing temperature-dependent physical behaviors. For example, amplifier 24 gain changes with temperature as do the characteristics of photo detectors, analog to digital converters, timing oscillator crystals, and reference voltage or current sources. It is also beneficial to use an internal temperature sensor to monitor and compensate for the temperature of objects within the pyrometer system that occupy any part of the field of view (“FOV”) of the photo detector.

Electronic circuitry 40, in combination with the techniques described herein, increases the signal-to-noise ratio of radiometric system 10 and allows temperature measurements to be made down to about 10° C. by measuring object emissions at or near 1,650 nm, and down to about 170° C. by measuring object emissions at slightly shorter than 1,000 mm. These conditions provide signal levels that have heretofore been too weak to measure accurately.

By comparison, the temperature measuring limits of prior optical radiometers operating at wavelengths shorter than 1,650 nanometers, with +5 degrees of noise, and a 1 Hz sampling bandwidth, is approximately 50° C. with a cooled/un-cooled indium gallium arsenide detector (“InGaAs”); or about 300° C. with a cooled/un-cooled silicon detector at 900 nm.

It should be noted that while the minimum temperature measuring limit is reduced by only a factor of two for the InGaAs detector and by a factor of about 1.6 for the silicon detector, the signal reduction at the detector is approximately a factor of 50 for the InGaAs detector and a factor of 3,000 for the equivalent silicon detector. This invention has enabled these minimum temperature measurement reductions through reducing optical losses, reducing or eliminating factors that cause signal level variations, and electronic signal processing improvements.

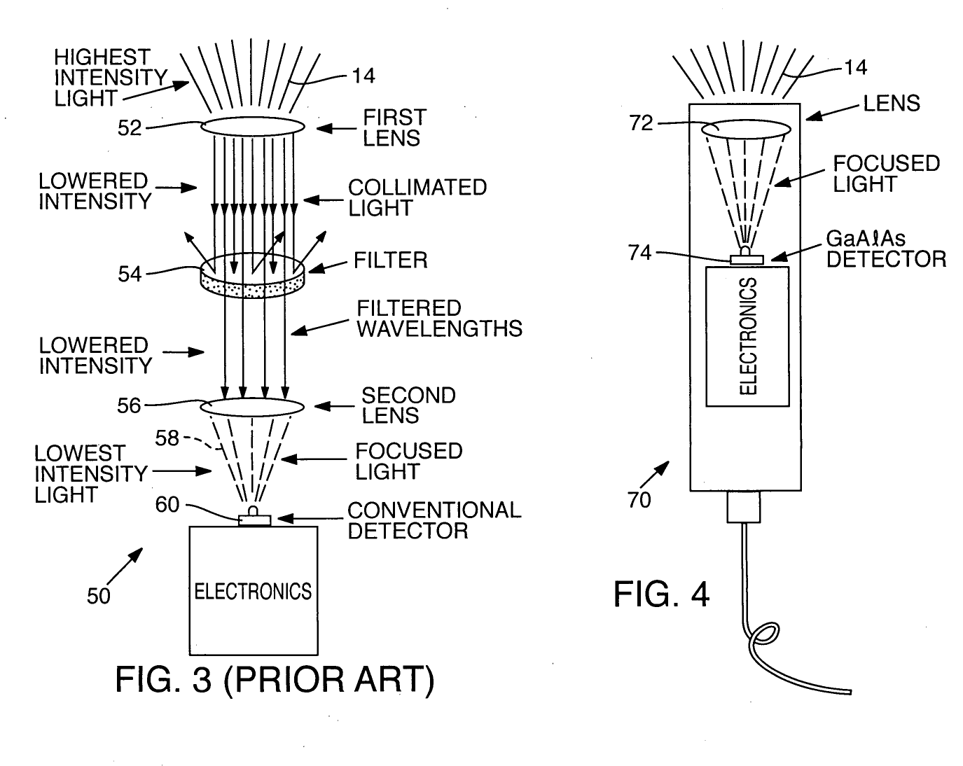

Regarding improvements that reduce optical losses, FIG. 3 shows a prior art optical pyrometer 50 employing a first lens 52 for collimating radiation 14 through a wavelength selective filter 54 and a second lens 56 for focusing filtered radiation 58 on a conventional silicon detector 60. Wavelength selective filter 54 transmits a desired radiation wavelength and blocks unwanted wavelengths. For example, long wavelength blocking filters block light at long wavelengths while transmitting short wavelengths of light. Unfortunately, filters do not transmit the desired radiation wavelengths with 100 percent efficiency, which causes optical losses that adversely affect the measurement system sensitivity. Moreover, filters work best with collimated light, which usually requires multiple lenses to collimate the light through the filter and then focus it on the detector. The multiple lenses further reduce the amount of light that reaches the detector.

In contrast, FIG. 4 shows an optical pyrometer 70 that employs a single lens 72 for focusing radiation 14 on a wavelength selective AlGaAs detector 74. The wavelength selective filtering achieved by AlGaAs detector 74 has a rapidly diminishing response as wavelength increases, enabling a measurement system having increased sensitivity because the losses associated with filter 54 and second lens 56 are eliminated. Also the angled light does not effect the wavelength sensitivity of the AlGaAs detector.

Miniaturization of the detector/electronics system and direct coupling to the light capturing source further increase the measurement sensitivity of the pyrometers suitable for use with this invention.

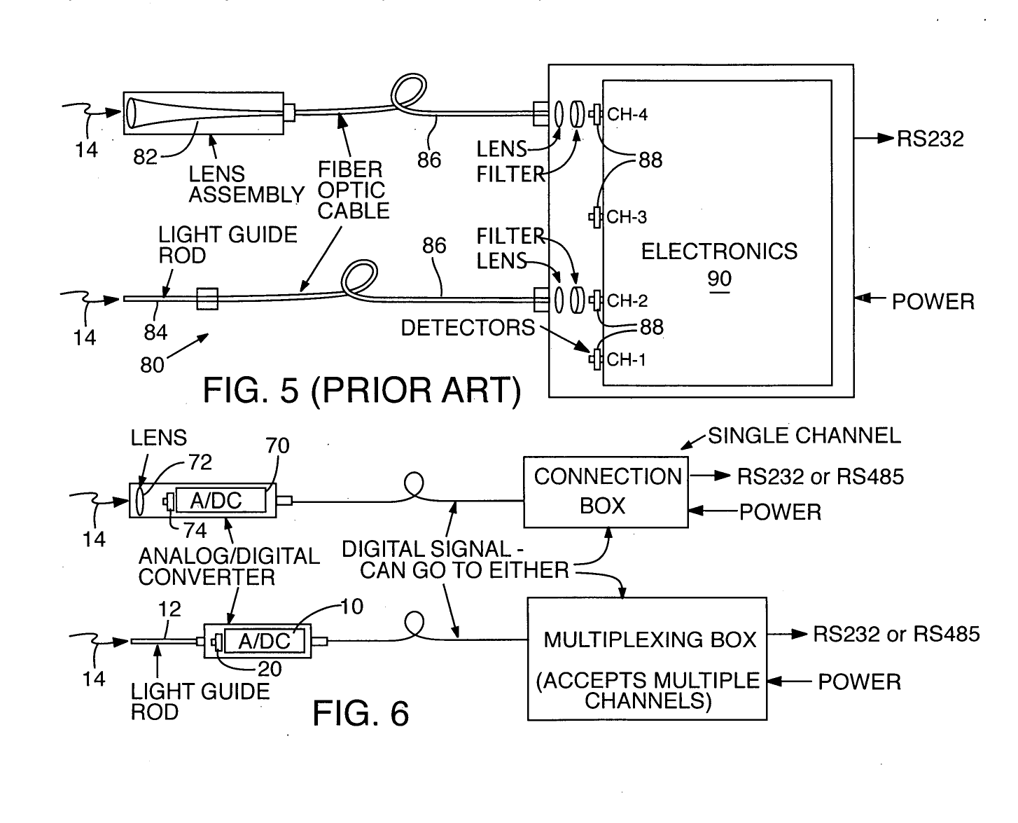

FIG. 5 shows a typical prior art pyrometer system 80 that employs a lens assembly 82 or a quartz or sapphire light guide rod 84 for collecting radiation 14 and propagating it onto an optical fiber or fiber bundle 86 for conduction to a detector 88. Light guide rod 84 or lens assembly 82 interfaces with the high temperature environment of the object. Optical fiber 86 isolates detector 88 and associated electronics 90 from electrical noise and heat and provides mechanical flexibility for placing detector(s) 88 in a convenient location. While this arrangement provides mechanical convenience, the following factors associated with using optical fibers 86 in semiconductor applications reduce their ability to accurately transmit radiation 14 to detector(s) 88:

1. If a single flexible fiber is employed to propagate radiation 14 from light guide rod (lightpipe) 84 to detector 88, then there will be large (˜80%) optical losses due to the difference in index of refraction and the fact that the flexible fiber is usually smaller in diameter than the lightpipe. If, instead, a fiber bundle is employed to propagate the radiation from the light guide rod (lightpipe) to the detector, significant loss of optical signal strength will still result due to the mismatched index of refraction and the fill factor of the bundle (the spaces between fibers) being less than 100 percent.

2. Because of the limited availability of glass types from which to make optical fiber 86, it is nearly impossible to achieve a numerical aperture that is equivalent to the index of refraction of light guide rod 84.

3. Unless optical fiber 86 includes an antireflection coating, reflection losses will exist at the glass-to-air interfaces at the ends of optical fiber 86. The reflection losses are exacerbated if the index of refraction is raised in an attempt to capture all of the light from light guide rod 84.

4. Because optical fiber 86 can only contain radiation that is traveling over a limited range of angles, radiation 14 that is captured by lens assembly 82 or light guide rod 84 and propagated into optical fiber 86 will have a variable loss if optical fiber 86 is flexed.

5. As optical fiber 86 is heated or cooled, its transmission characteristics change causing transmitted signal variations.

6. When employing an optical fiber cable, errors are easily introduced at both ends of the cable: first, through misalignment of the cable ends when they are connected to the light guide rod 84 and photo detector 88, and secondly due to imperfect cleaning of the two surfaces. Moreover, when optical fiber 86 is attached and removed from the radiation collection system or detector 88, alignment changes can occur causing variations in the transmitted light.

By way of comparison, FIG. 6 shows that in this invention, the losses and signal variations associated with optical fibers are eliminated by eliminating optical fiber(s) 86 and directly coupling detector 20 to light guide rod 12 and/or detector 74 to lens 72 of respective pyrometers 10 (FIG. 1) and 70 (FIG. 4). To accomplish this in a mechanically effective way, the detector and supporting electronics are miniaturized as shown in FIG. 1 to fit into space-constrained locations.

As the device geometry of ICs becomes ever smaller, the measurement of lower temperatures becomes more critical for these processes. As temperatures decrease, the amount of radiation emitted by the wafer also decreases. Therefore, the radiation transmission efficiency of light guide rods coupled to detectors become ever more critical to accurate temperature measurements.

Moreover, as the price of IC's decreases, extreme cost-reduction pressure has been placed on semiconductor equipment manufacturers. Given the high cost of sapphire, the current state-of-the-art material for fabricating light guide rods, alternative materials have long been sought after for making light guide rods.

Accordingly, the pyrometer suitable for use with this invention includes an improved light guide rod material for reducing the optical losses encountered when employing optical pyrometry in, for example, semiconductor processing applications. This improved material is formed of aluminum oxide single crystal, the preferred type being YAG, which provides increased light transmission characteristics, resulting in improved low temperature measurement capabilities. A suitable alternative light guide rod material is yttrium aluminum perovskite (“YAP”). Recent processing improvements have allowed manufacturing YAG and YAP in rod lengths and form factors suitable for use in optical pyrometry applications.

YAG retains many of the benefits of sapphire, in that it is very similar in hardness (MOHS hardness of 8.2 vs. 9 for sapphire), melting point (1,965° C. vs. 2,050° C. for sapphire), and ability to withstand thermal shock. These unexpected benefits make YAG ideally suited for fabricating light guide rods 12 and 84 used in temperature sensing for semiconductor applications.

While YAG has been used for other optical applications such as in lasers, hitherto it could not be grown long enough and was usually doped, so it has never been considered as a potential light guide rod material. However, the increased demand for YAG for other applications resulted in major manufacturing advances, with producers now able to grow it in lengths up to one meter. This recent development and additional new research in un-doped YAG has led to the unexpected discovery of many properties that make YAG ideally suited for use in semiconductor applications. For example, when compared to sapphire, the YAG material:
reduces optical losses because of its higher index of refraction and better crystal structure;
reduces or eliminates factors which cause variations in the signal level due to lack of uniformity from light guide rod to light guide rod;
is less affected by surface contamination;
provides tighter machining tolerances;
reduces the light guide rod's thermal conductivity; and
as opposed to sapphire, YAG is easier to machine into round rods because of its crystal structure.

Regarding reduced optical losses, YAG has a higher refractive Index, resulting in better radiation transmission. When fabricating light guide rods, a ferrule is attached to the light guide rod as a means of securing the rod to the pyrometer. An O-ring is also typically attached to the rod to provide a seal between the rod and the wafer-processing chamber into which the rod is inserted. However, when these parts contact the rod, radiation can be scattered at the contact points. Care must be taken, therefore, in selecting materials with a high refractive index to prevent radiation from scattering at the contact points. Accordingly, only sapphire and quartz rods and fibers have been used in prior semiconductor applications. While these materials provide a high refractive index, a consistent problem (particularly with quartz) has been that radiation is still scattered at the ferrule and O-ring contact points, thus reducing the light guide rod's transmission capabilities.

An improvement therefore would be to employ a material having characteristics similar to sapphire or quartz but with a higher refractive index to reduce the amount of scattered radiation at the contact points. Because YAG has a higher refractive index (1.83 at 632.8 nm) than sapphire or quartz, it is less sensitive to radiation losses at the contact points and is, therefore, ideally suited as an improved light guide rod material.

When fabricating light guide rods, it is important to obtain highly polished rod sides to prevent radiation from scattering out of the guide rod sides. Because quartz is a soft material it is difficult to prevent scratches on the sides of quartz rods. On the other hand, because sapphire is such a hard material, it is difficult to polish out all the scratches produced on sapphire rods during their manufacture.

YAG is harder than quartz but not quite as hard as sapphire, making it ideally suited for fine side polishing, thereby preventing radiation from scattering from the sides of YAG rods.

When fabricating IC's (which now have device geometries as small as 0.11 microns), it is critical that the IC manufacturing equipment be uniform from tool to tool. Consequently, each component of a semiconductor-fabricating tool must maintain a very high level of uniformity, including a high level of uniformity among light guide rods. YAG provides several unexpected benefits for providing such uniformity, which could not be achieved with sapphire or quartz. These benefits include:
YAG has no birefringence, so it provides more uniform light collection;
YAG is an isotropic material, so it eliminates problems with growth misalignment and/or machining misalignment that are common to sapphire; and
YAG can be machined more easily to a tolerance as low as ±0.0001 inches, whereas sapphire can only be machined easily to a tolerance of ±0.001 inches.

The accuracy of pyrometers can be improved by preventing unintended heat from reaching the detector. When using light guide rods for transmitting radiation from the wafer to the detector, the light guide rod can itself become hot and conduct heat from the process chamber in addition to radiation from the wafer, causing temperature measurement errors. Consequently, the light guide rod should have a low level of thermal conductivity.

Fortunately, YAG has a lower level of thermal conductivity than sapphire. An additional benefit is that lower temperature epoxies can be used for securing ferrules to the YAG rods, and O-rings having lower heat resistance can be used.

Another series of improvements for facilitating the measurement of low temperatures is the reduction or elimination of factors causing signal level variations. A number of such factors have been identified, and techniques to improve or eliminate them have been developed as described below.

When using a light guide rod as a radiation collection system, the rod-to-detector coupling efficiency may be reduced by foreign matter that accumulates on the optical faces of the rod and detector. In particular, foreign particles can be deposited on the surfaces when the rod and detector are disconnected. In addition, the mechanical movement associated with connecting and disconnecting the rod deposits debris on the interface surfaces. This debris may adversely affect the measurement system calibration.

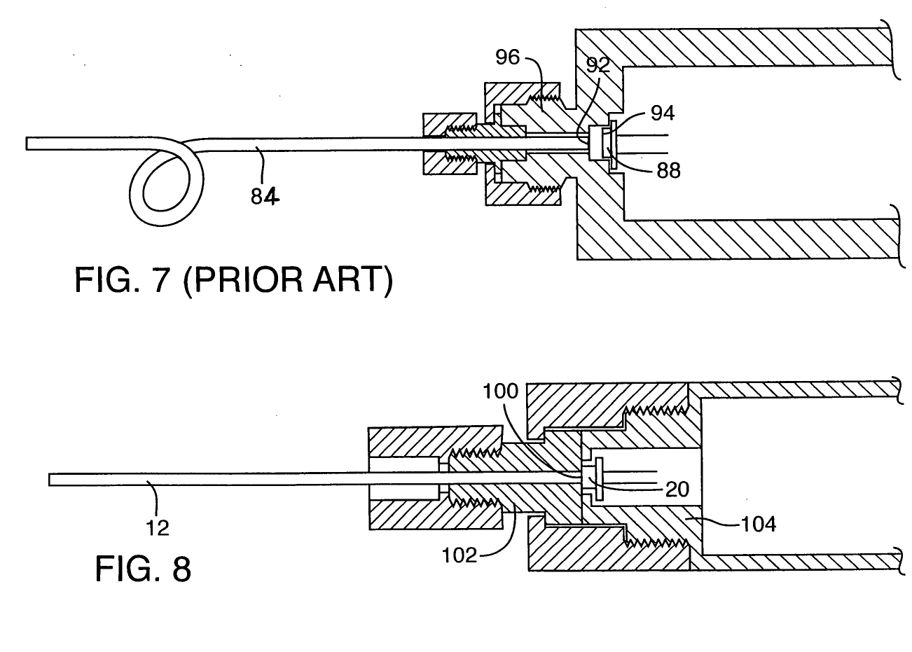

FIG. 7 shows a mounting system for prior art light guide rod 84 and detector 88 in which an optical face 92 of light guide rod 84 and an optical face 94 of detector 88 are recessed within a threaded housing 96. This configuration makes cleaning of optical faces 92 and 94 difficult and ineffective.

In contrast, FIG. 8 shows a mounting system for light guide rod 12 and detector 20 in which optical faces 100 of light guide rod 12 and detector 20 are flush to the edges of their respective housings 102 and 104 and are, therefore, closely coupled. The flush mounting facilitates easy and effective cleaning of optical faces 100. The close coupling also improves rod-to-detector optical coupling and, thereby, reduces signal transmission variations.

Referring again to FIG. 1, when taking temperature measurements with radiometric system 10, it is important to block undesirable wavelengths of radiation 14 to reduce errors introduced by heat build-up in filter 18 and detector 20 and to prevent damage to photo detector 20 caused by the undesired wavelengths. Undesired wavelengths of radiation 14 are typically blocked by using filters. Two improved ways of blocking undesired wavelengths are:

When a blocking filter, such as filter 18, performs its function by absorbing radiation, the absorbed energy causes filter 18 to increase in temperature, which changes the blocking characteristics of filter 18, altering the response of the measurement system, and resulting in temperature measurement errors. These errors can be prevented by introducing an additional blocking system for impeding undesirable wavelengths of radiation 14.

A preferred way of accomplishing this additional blocking is to place reflective hot/cold mirror surface 22 coating on filter 18. Hot/cold mirror surface 22 preferably causes minimal change in the spectral characteristics of filter 18 in the desired wavelengths yet transmits wanted wavelengths of radiation 14 while reflecting undesired wavelengths as undesired radiation 120.

Reflecting the undesired radiation 120 back through collection optics 12 (light guide rod or lens) to the location being measured on object 16 is advantageous for the following reasons: the temperature of object 16 is not significantly altered because much of radiation 14 is returned to object 16; and filter 18, photo detector 20, and the associated electronics are more stable because they are not unduly heated by radiation 14.

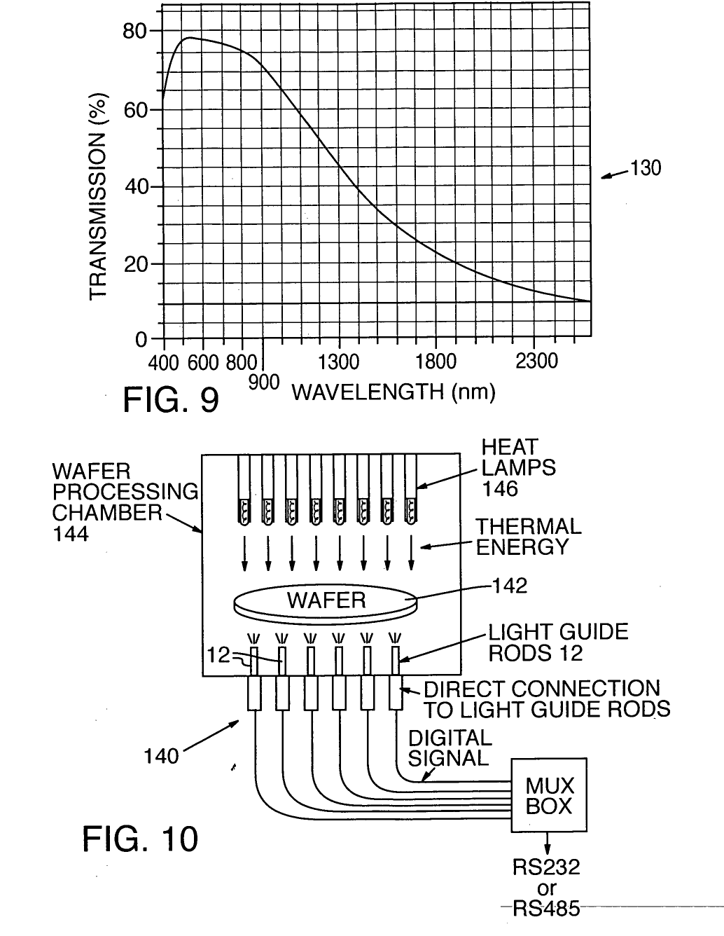

FIG. 9 shows a preferred response curve 130 for hot/cold mirror surface 22. Hot/cold mirror surface 22 passes at least 70 percent of radiation 14 at about 900 nm and reflects substantial amounts of undesired radiation 120 at wavelengths above about 1,200 nm. Skilled workers will understand that hot/cold mirror surface 22 can be formed from a variety of suitable metallic and dielectric materials.

The response of a detector to radiation 14 and the electrical noise level it generates is a function of its operating temperature. Radiation wavelengths incident on the detector may not produce an electrical signal, but they may alter any existing signal by changing the detector temperature. In particular, short wavelength radiation may permanently alter the response characteristics of the detector. This radiation damage is prevented in part by the above-described hot/cold mirror surface 22 and also by filter 18, which further blocks unwanted radiation wavelengths from the detector. An advantage of the hot/cold mirror is that it prevents UV damage and IR heating, which causes a shift in the wavelength response of the photo detector and also causes electrical noise.

FIG. 10 shows a pyrometer system 140 suitable for use with this invention employed in a typical semiconductor processing application. A major application of pyrometer system 140 is measuring the temperature a silicon wafer 142 as it is heated in a processing chamber 144 by high-power lamps 146 or plasma (not shown). Lamps 146 are typically mounted on the opposite side of silicon wafer 142 from light collection optics 12.

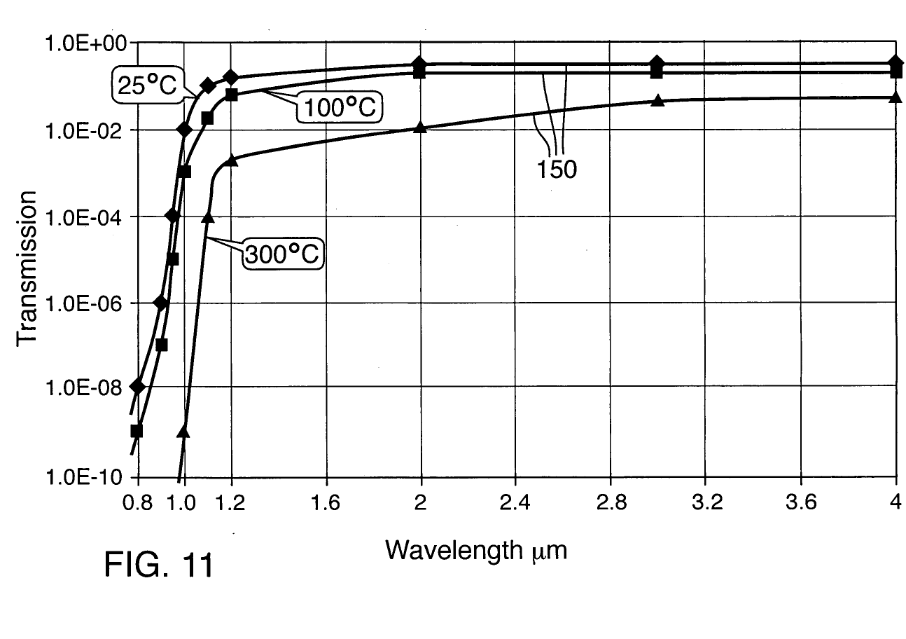

FIG. 11, shows graphs 150 representing the transmission of radiation through a silicon wafer as a function of wavelength and temperature. Graph 150 shows that silicon wafer 142 is transparent to radiation beyond a wavelength of about 1,000 nm. Therefore, it is important to block radiation beyond 1,000 nm to prevent detector and filter heating that would cause temperature measurement errors.

A common technique for achieving wavelength blocking is employing a short wavelength pass filter, which is fabricated by vacuum evaporation of optical materials having varying indices of refraction. By stacking a series of such materials, typically alternating high and low indices or refraction, a coating is produced that reflects or absorbs radiation over a limited range of wavelengths. To achieve blocking over a broad range of wavelengths, it is necessary to place successive stacks on top of each other such that each stack blocks a different wavelength range.

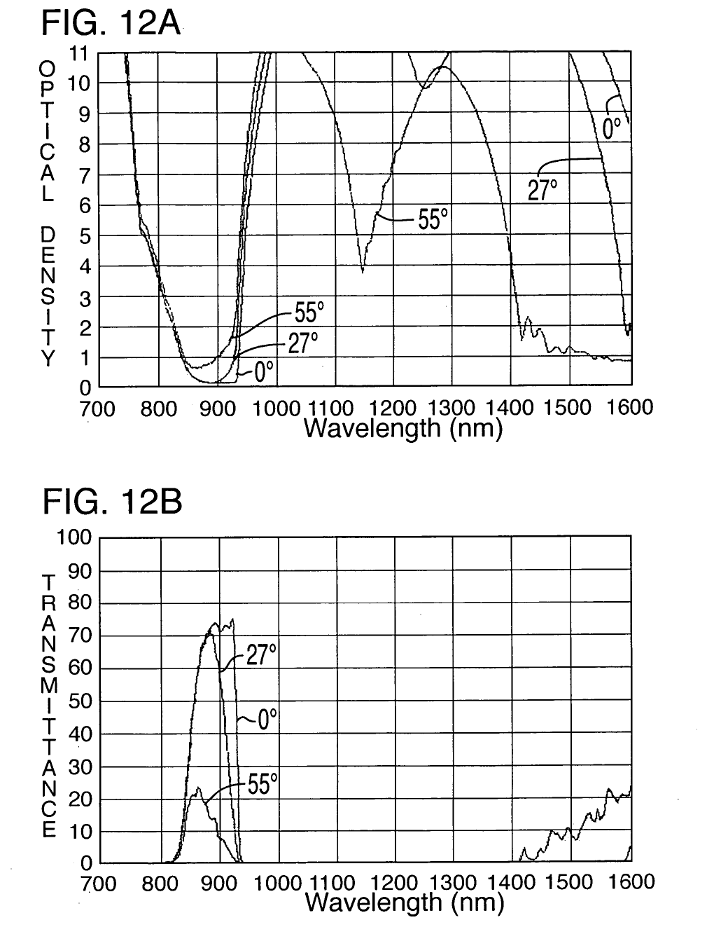

FIGS. 12A and 12B represent the respective optical density and transmittance versus wavelength and radiation incidence angle of a short wavelength pass filter that us suitable for use with this invention. Skilled workers will understand how to make such a filter. As shown in the graphs, this technique is most effective if the radiation is incident to the filter over a range of angles less than about 27 degrees. However, if the radiation is incident over a wide range of angles, e.g., up to about 55 degrees, the wavelength blocking characteristics are altered.

A suitable short wavelength pass filter, therefore, includes a blocking coating that includes as a design parameter the numerical aperture of the light guide rod or optical fiber that propagates the light from the sample to the detector.

Another embodiment of a pyrometer suitable for use with this invention employs gallium aluminum arsenide (“AlGaAs”) and other wavelength-selective detector materials in place of band pass filters.

FIGS. 13 and 14 represent the respective absorption coefficient and photo sensitivity of various detector materials as a function of wavelength. Conventional pyrometer detectors utilize either InGaAs or silicon detectors. InGaAs detectors are sensitive to radiation wavelengths as long as 2,700 nm, which makes blocking very difficult. Silicon detectors are nominally insensitive to wavelengths longer than 1,300 nm, however the photo sensitivity of silicon diminishes with longer wavelengths.

An aspect of this invention, therefore, is to utilize a detector material having a photo sensitivity that diminishes rapidly at wavelengths at which silicon wafers begin to transmit radiation. A preferred detector material is AlGaAs, which has a photo sensitivity that peaks at 900 nm and diminishes by about three orders of magnitude at 1,000 nm. Alternatively, detectors materials such as GaP, GaAsP, GaAs, and InP are suitable for use as wavelength-selective detectors at wavelengths less than 1,000 mm.

The photo detector materials for wafer temperature measurements are chosen for photo sensitivity around the optimum wavelengths for measuring silicon, GaAs, and InP wafers. In particular, the material is chosen for sensitivity at wavelengths shorter than the 1,000 nm (bandgap for silicon wafers), yet as long as possible to provide a maximum amount of Planck Blackbody Emission without significant sensitivity to radiation transmitted through the wafer.

The photo detector suitable for use with this invention is made from AlGaAs, a tertiary compound, and is doped to optimize its photo sensitivity around 900 nm. This detector material is advantageous because it is insensitive to radiation wavelengths transmitted through a silicon wafer, and to much visible ambient light. It is also advantageous because it has a narrow wavelength detection sensitivity, minimizing the need for an additional wavelength selective filter. A suitable detector is manufactured by Opto Diode Corporation, located in Newbury Park, Calif.

Of course, in situations where sharper cutoff is desired, the detector can be combined with a filter to achieve a wavelength selectivity compounding affect. In these situations, it is also easier to design and manufacture band pass filters that are matched for use with the particular detector material.

The ability to eliminate the filter altogether (along with the ability to use a simple band-pass filter when one is required) further allows the detector to be spaced much closer (0.25 mm verses 2.54 mm) to the light pipe, enabling collecting about ten times more radiation. The close spacing also provides better low temperature measurement performance, e.g., the ability to measure 200° C. compared to 350° C. with a traditional band-pass filter and a silicon broad band detector.

As shown in FIG. 15, detector photo sensitivity changes with temperature, which causes output current variations that correspond to temperature measurement errors. Prior methods for dealing with this problem are to:
1) not correct for the error and simply specify a lower accuracy/repeatability specification;
2) use a band pass or cutoff filter to attenuate the detector wavelength selectivity skirts, thereby eliminating most of the spectral shifting variations; and
3) calibrate errors out by taking a set of measurements at various ambient and target temperatures and use the resulting data to extrapolate correction data.

Method 1 is clearly unacceptable for precision measurements.

Method 2 works well, although there are some remaining fluctuations caused by spectral shifts in the filter and detector. This method also significantly reduces the ability to measure lower temperatures because infrared wavelengths of interest are attenuated by the filter.

Method 3 also works well but is limited to the calibrated range of temperatures and is only relevant to systems of a similar configuration. The accuracy of this method is also limited by the conditions under which the data are taken and diminishes with higher target temperatures because of the difficulty of making accurate blackbody furnace measurements at these temperatures. In addition, this method is time consuming, limited in flexibility, and is not based on first principles of physics, making it prone to inaccuracies.

An improved method is to employ correction data generated from detector photo sensitivity curves as a function of wavelength, such as the curves shown in FIG. 15. A detector that is representative of the detectors used in a particular instrument model, is characterized with a monochromator at various ambient temperatures, such as −20, −10, 0, 10, 20, 25, 30, and 40 degrees C., to generate a set of data. The data are then used to generate scale factor correction data for detector current vs. temperature using the Planck equation and integrating the area under the spectrum curve vs. target temperature.

The data entered into the software are ambient dependent detector spectrum curves, minimum theoretical target temperature, maximum theoretical target temperature, and one actual predetermined target temperature.

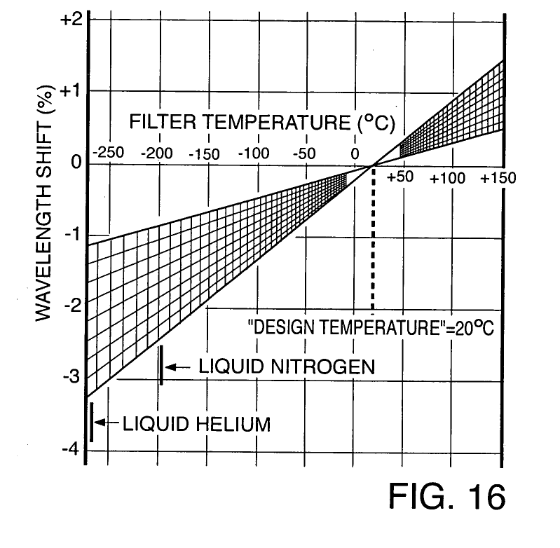

This same correction method can be used for correcting for other optical components, such as optical filters that vary with ambient temperature. FIG. 16 shows a set of graphical data representing wavelength shift as a function of temperature for typical infrared interference filters. Suitable correction data can be extracted from such data.

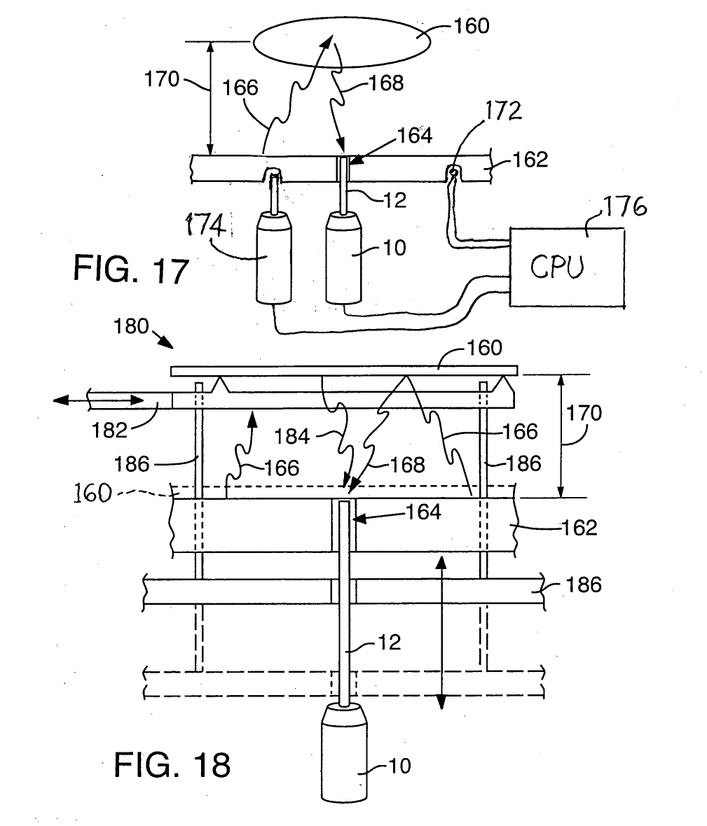

FIG. 17 shows a semiconductor wafer 160 undergoing an in-situ temperature measurement method employing radiometric system 10 of this invention. In-situ semiconductor wafer measurements are common place in IC fabrication facilities around the world. There are, however, numerous technical problems with measuring the temperatures of production wafers, such as semiconductor wafer 160, when the Planck Equation is used to calculate its temperature from radiation emitted by a “hot” wafer.

For a wafer having a temperature above about 300° C., these technical problems include the unknown emissivity of semiconductor wafer 160, and measurement errors caused by reflected background radiation. The unknown wafer emissivity causes large errors in temperature measurement because typical semiconductor wafer emissivities range from about 0.1 for metal films like copper to about 0.9 for oxides of certain thickness. Semiconductor wafer emissivity is a strong function of film type and thickness for both single- and multi-layer films deposited on both the front and backside of the semiconductor wafer 160. Emissivity is also a function of the measurement wavelength and radiation collection angles employed by radiometric system 10.

A preferred wafer temperature measurement method of this invention addresses sources of measurement error caused by unknown emissivity and reflected background radiation in processing applications that include a heated susceptor. Many semiconductor processing tools include one or more heated susceptors, which are commonly referred to as chucks, wafer holders, workpiece supports, or hot plates. Susceptors such as heated susceptor 162 are often manufactured from graphite that is typically coated with either silicon carbide or boron nitride. Susceptors may also be manufactured from aluminum, aluminum nitride, and silicon. The manufacture of susceptors, such as hot susceptor 162 is tightly controlled because its parameters directly impact the processing of semiconductor wafer 160. For example, hot susceptor 162 has a tightly controlled surface texture, finish, and coating(s) to control among other things, contamination, heat transfer, and gas flow.

The temperature of hot susceptor 162 is also tightly controlled during processing of semiconductor wafer 160, typically by employing closed loop feedback from sensors, such as a thermocouple 172 or a second radiometric system 174, either of which is coupled to a CPU 176. Other suitable temperature measuring devices include resistance temperature devices, platinum resistance thermometers, thermisters, and optical thermometers.

The semiconductor wafer temperature measurement method of this invention takes advantage of the tight control of the surface conditions and temperature of hot susceptor 162, which tight control provides known and reproducible radiation emissions from hot susceptor 162. The known amount of radiation emitted by hot susceptor 162 is employed as a stable radiation source for making precise reflectance measurements of semiconductor wafer 160.

Collection optics 12 of radiometric system 10 is positioned in and sensing radiation through an opening 164 in hot susceptor 162. Hot susceptor 162 emits emitted radiation 166, which reflects off semiconductor wafer 160 as reflected radiation 168 that enters collection optics 12, and is sensed by radiometric system 10. When semiconductor wafer 160 is initially loaded in a processing chamber, it is relatively cold and, therefore, emits very little radiation. At this time, while semiconductor wafer 160 is separated from hot susceptor 162 by a gap 170, most of the radiation sensed by radiometric system 10 is reflected radiation 168 originating from hot susceptor 162. Semiconductor wafer 160 is then moved toward hot susceptor 162, while radiometric system 10 makes multiple real-time measurements of reflected radiation 168. Because the amount of reflected radiation 168 varies as gap 170 diminishes toward zero, radiometric system 10 senses information indicative of the reflectance and roughness of semiconductor wafer 160. Semiconductor wafer 160 typically comes to rest on hot susceptor 162 as shown in dashed lines.

A process tool, typically a robot, has a fixed geometry and moves semiconductor wafer 160 toward hot susceptor 162 in a very reproducible manner. This makes it practical to calculate the amount of emitted radiation 166 by using the Planck Blackbody equation, then based on this result, to calculate the reflectivity of semiconductor wafer 160. The emissivity of semiconductor wafer 160 can then be calculated using Kirchhoff's 1860 radiation law, which is expressed as:
1−R=ε, (1)
where R is the reflectivity, and E is the emissivity.

Using Kirchhoff's law provides nearly 100 percent accurate and valid results because hot susceptor 162 is a very uniform and diffuse emitter, thereby illuminating semiconductor wafer 160 in a nearly hemispherical (all angles) manner, which is required for proper application of the law. Skilled workers understand that actual semiconductor wafers require only about a 50° total cone angle for reliable emissivity calculations when employing Kirchhoff's law.

### EXAMPLE

FIG. 18 shows a semiconductor wafer processing apparatus 180 suitable for carrying out the temperature measurement method of this invention. A horizontal transporter 182 moves semiconductor wafer 160 by its peripheral margins into position above and spaced apart from hot susceptor 162 by the distance of gap 170, which typically ranges from about 2.54 cm (1.0 inch) to about 0.0254 mm (0.001 inch). Note that horizontal transporter 182 does not substantially block the surface of wafer 160 from hot susceptor 162 or radiometric system 10. As wafer 160 is moved horizontally into position, cool semiconductor wafer 160 emits some emitted radiation 184, which is sensed by radiometric system 10. Emitted radiation 184 is initially small and increases when semiconductor wafer 160 is heated during subsequent lowering toward hot susceptor 162. Before lowering semiconductor wafer 160, emitted radiation 166 from hot susceptor 162 that is reflected by semiconductor wafer 160 as reflected radiation 168 provides a baseline radiation measurement for comparing with measurements taken during the subsequent downward motions of semiconductor wafer 160. Hot susceptor 162 typically has a predetermined temperature in a range from 70° C. or less to about 1,300° C.

A vertical transporter 186 lifts semiconductor wafer 160 off horizontal transporter 182, which moves out from under semiconductor wafer 160. Vertical transporter 186 then commences moving semiconductor wafer 160 toward hot susceptor 162, which movement time ranges from a fraction of a second to a few second. As semiconductor wafer 160 moves downward, its reflected emission 168 is measured by radiometric system 10 in real time as a function of diminishing gap 170. This relationship is employed to calculate the effective reflectivity of semiconductor wafer 160. This calculation employs the well-known relationship shown below in Eq. 2, which relates the effective or apparent emission to substrate emission when a narrow gap exists between a workpiece (e.g., wafer) and an object (e.g., susceptor).

$${ɛ}_{A} = \frac{ E + ( 1 - E ) \cdot R \cdot \\ BBemissionRation ( λ , {T}_{WORKPIECE} , {T}_{SUSCEPTOR} )}{1 - ( 1 - E ) R} \qquad ( 2 )$$

where, ε_{A} is the effective workpiece emissivity, E is the real emissivity of the susceptor, R is the real reflectance of the workpiece, and BB is the blackbody emission from the hot susceptor.

This information may also be employed to characterize the roughness of semiconductor wafer 160, which roughness influences the directionality and, therefore, the intensity of radiation collected by collection optics 12. Gap 170 diminishes as semiconductor wafer 160 is lowered onto hot susceptor 162 (as shown in dashed lines). Therefore, the amount and angular components of radiation received by collection optics 12 also changes. This change is dependent on the reflectivity and roughness of semiconductor wafer 160, which can be employed to calculate (Eq. 1) the emissivity of semiconductor wafer 160 and, thereby, its temperature.

Skilled workers will recognize that portions of this invention may be implemented differently from the implementations described above for preferred embodiments. For example, the description above applies primarily to temperature measurements of target media, but also applies to various forms of light measurements. Skilled workers will also recognize that this invention is not limited to the advanced pyrometer described above, but can also be used to complement standard single-, dual-, or multi-wavelength pyrometry. Notably, the target media may include semiconductor wafers undergoing any of epitaxial growth processing, chemical vapor deposition, plasma assisted chemical vapor deposition, and physical vapor deposition. The measurement methods are also usable for steel undergoing galvanneal processing, and for use in aluminum sheet processing.

It will be obvious that many changes may be made to the details of the above-described embodiments of this invention without departing from the underlying principles thereof. Accordingly, it will be appreciated that this invention is also applicable to temperature measurement applications other than those found in semiconductor wafer processing. The scope of this invention should, therefore, be determined only by the following claims.

I claim:

1. A method for determining parameters of a target medium emitting target medium radiation, comprising:
providing a heated susceptor emitting a known amount of susceptor radiation;
positioning the target medium an initial distance apart from the heated susceptor such that the susceptor radiation reflects off the target medium as reflected radiation and the target medium radiation is substantially less than the reflected radiation;
measuring the reflected radiation and the target medium radiation to determine a baseline amount of radiation;
moving at least one of the target medium and the heated susceptor toward each other to heat the target medium such that the target medium radiation increases as the initial distance decreases toward a final distance;
measuring a change in the amount of target medium radiation and reflected radiation as the distance decreases; and
calculating a reflectivity of the target medium by employing a relationship between the baseline amount of radiation and the change in the amount of target medium radiation and reflected radiation.

2. The method of claim 1, further including calculating an emissivity of the target medium by employing the reflectivity of the target medium.

3. The method of claim 2, further including calculating a temperature of the target medium by employing its emissivity.

4. The method of claim 1, further including calculating the amount of the target medium radiation by employing a Planck Blackbody radiation equation.

5. The method of claim 1, in which the heated susceptor has a predetermined temperature in a range from about 70 degrees centigrade to about 1,300 degrees centigrade.

6. The method of claim 1, in which the initial distance is about 2.54 centimeters (1.0 inch) or less.

7. The method of claim 1, in which the final distance is about 0.0254 millimeters (0.001 inch) or greater.

8. The method of claim 1, in which the target medium includes a semiconductor wafer.

9. The method of claim 1, in which the measuring is carried out with a pyrometer.

10. The method of claim 9, further including providing an opening in the heated susceptor and positioning the pyrometer to measure radiation arriving at the opening.

11. The method of claim 9, in which the pyrometer includes a probe element including a light guide formed from a material including an aluminum oxide single crystal.

12. The method claim 11, in which the light guide formed from the aluminum oxide single crystal material includes at least one of a yttrium aluminum garnet (YAG) and yttrium aluminum perovskite (YAP).

13. The method of claim 9, in which the pyrometer includes a probe element including a light guide material including at least one of quartz and sapphire.

14. The method of claim 9, in which the pyrometer includes a solid-state detector material including gallium aluminum arsenide (AlGaAs).

15. The method of claim 14, in which-the solid-state detector material includes a spectral response characteristic having a radiation response that peaks at about 900 nm.

16. The method of claim 1, in which the target medium includes a semiconductor wafer undergoing at least one of epitaxial growth processing, chemical vapor deposition, plasma assisted chemical vapor deposition, and physical vapor deposition.

17. The method of claim 1, in which the target medium includes steel undergoing galvanneal processing.

18. The method of claim 1, in which the target medium includes an aluminum sheet undergoing processing.

19. The method of claim 1, in which the heated susceptor is formed from a material including at least one of graphite, aluminum, aluminum nitride, and silicon.

20. The method of claim 1, in which the moving includes moving the target medium toward the heated susceptor.

21. The method of claim 1, in which the measuring employs a pyrometer including a lens for collecting the target medium radiation and the reflected radiation.

22. The method of claim 1, further including providing a pyrometer for measuring a temperature of the heated susceptor.
